(19) United States
(12) Patent Application Publication
(10) Pub. No.: US 2016/0280062 A1
(43) Pub. Date: Sep. 29, 2016

(54) WIND POWERED VEHICLE SYSTEM

(71) Applicant: Beverly Custis Diggs Edwards, JR., Oden, AR (US)

(72) Inventor: Beverly Custis Diggs Edwards, JR., Oden, AR (US)

(21) Appl. No.: 14/546,779

(22) Filed: Nov. 18, 2014

(51) Int. Cl. B60K 16/00; F03D 9/28; F04B 39/06; F03D 9/00

(52) U.S. Cl. CPC B60K 16/00; F03D 9/001; F03D 9/28; F04B 39/06; B60K 2016/006

(57) ABSTRACT

A wind powered vehicle having a high pressure, heavily insulated air tank mounted to the vehicle that is charged with compressed air from a high pressure accumulator storage tank. The air stored in the accumulator tank is air that is highly compressed by an air compressor that is driven by a stationary wind turbine, the air compressor being mounted in the hub of the wind turbine to facilitate efficiency and to allow the wind turbine to rotate so as to catch the wind, regardless of the direction of the wind. Couplings and insulation are provided to allow the vehicle mounted air tank to be releasably coupled to the accumulator tank and to conserve the heat energy of the highly compressed air.

### BACKGROUND OF THE INVENTION

This application is a continuation-in-part of my co-pending application Ser. No. 13/874,091, filed Apr. 30, 2013, and titled WIND POWERED VEHICLE SYSTEM, the disclosure of which is hereby incorporated into this application in its entirety by this specific reference to that prior pending application.

The field of the invention relates to a vehicle system powered by wind generated compressed air. More particularly, the invention relates to a large wind driven turbine that drives an air compressor for producing compressed air and a compressed air powered vehicle engine which receives and uses the wind turbine generated compressed air. The vehicle could be such as an automobile, truck or tractor. The invention, known as the Wind Powered Vehicle System, is unique in that it runs on compressed air generated by a wind turbine powered air compressor. Conventional vehicles use petroleum fuels such as gasoline or diesel, which when burned to drive the engine, emit air pollution or greenhouse gases such as carbon dioxide. This air pollution is harmful to the health of living creatures and may cause global warming. Petroleum or fossil fuels are not renewable resources. The Wind Powered Vehicle System of the present invention runs on a totally renewable resource fuel which is air, and it emits no air pollution in any part of the system. Conventional existing petroleum fueled vehicles can be modified to run on compressed air with the Wind Powered Vehicle System by removing their petroleum fueled engine and fuel tank and replacing it with the Wind Powered Vehicle System engine and drive train and compressed air fuel tank.

The purpose of the Wind Powered Vehicle System is to reduce the effects of the dramatic increase in the content of carbon dioxide in the earth's atmosphere, which is causing global warming and climate change. The National Oceanic and Atmospheric Administration documents the growth of CO2 in our atmosphere, which is deadly. The CO2 content has risen from 300 parts per million (ppm) in 1960 to 400 ppm in 2014. The warmest year ever recorded is 2014. Earth scientists at the United Nations Intergovernmental Panel on Climate Change concluded that the effects of climate change could become irreversible unless the world cuts its greenhouse gas emissions from burning fossil fuels. Earth scientists conclude that continued global warming will significantly harm life on earth, and this is already being observed.

It is, therefore, an object of the present invention to provide a vehicle that does not emit hydrocarbons.

Another object of the present invention is to reduce, and perhaps even reverse the increase in, the production of greenhouse gases that contribute to global warming from climate change.

Another object of the present invention is to provide a renewable fuel source for powering a vehicle, thereby reducing dependency on fossil fuels.

Yet another object of the present invention is to provide a vehicle with reduced operating cost as compared to the cost of operating a vehicle powered by an internal-combustion engine that is fueled by fossil fuels.

This listing of some of the objects of the present invention is intended to be illustrative. Other objects, and the many advantages of the present invention, will be made clear to those skilled in the art in the following detailed description of the preferred embodiment(s) of the invention and in any drawing(s) appended hereto. Those skilled in the art will recognize, however, that the embodiment(s) of the present invention described herein are only examples of specific embodiment(s) of the invention, set out for the purpose of describing the making and using of the invention, and that the embodiment(s) shown and/or described herein are not the exclusive way(s) to implement the teachings of the present invention.

### BRIEF SUMMARY OF THE INVENTION

All of the components of the Wind Powered Vehicle System of the present invention are currently available today as off of the shelf hardware, which is currently being manufactured. This is an application that combines existing proven hardware components into a unique system that powers a vehicle with non-polluting compressed air, that is generated by a wind turbine powered piston type air compressor. The basic components are a large land based wind turbine that drives a piston type air compressor, that pipes compressed air into a high pressure insulated storage tank, that then pipe compressed air into a vehicle insulated compressed air fuel tank, that fuels a piston driven air motor, that drives the vehicle. All of the individual components of the system have been in service for a long time in other applications.

### BRIEF DESCRIPTION OF THE DRAWINGS

FIG. 1 is a top perspective view of the whole assembled Wind Powered Vehicle System.

FIG. 2 is a front elevation view of the large wind turbine, with its horizontal wind turbine axle that direct drives the piston type air compressor that furnishes high pressure compressed air to the system.

FIG. 3 is a side elevation view of the large wind turbine, with its horizontal wind turbine axle that direct drives the piston type air compressor that furnishes high pressure compressed air to the system.

FIG. 4 is a plan view of the Wind Powered Vehicle, which is fueled with compressed air from the piston type air compressor that is mounted on the wind turbine axle.

FIG. 5 is a side elevation view of the Wind Powered Vehicle, which is fueled with compressed air from the piston type air compressor that is mounted on the wind turbine axle.

FIG. 6 has graphs showing that CO2 content in the earth's atmosphere has grown dramatically from about 300 parts per million (ppm) in the year 1960 to 400 ppm in 2014. The graphs are presented by the National Oceanic and Atmospheric Administration (NOAA) from their laboratory in Mauna Loa, Hawaii.

### DETAILED DESCRIPTION OF THE INVENTION

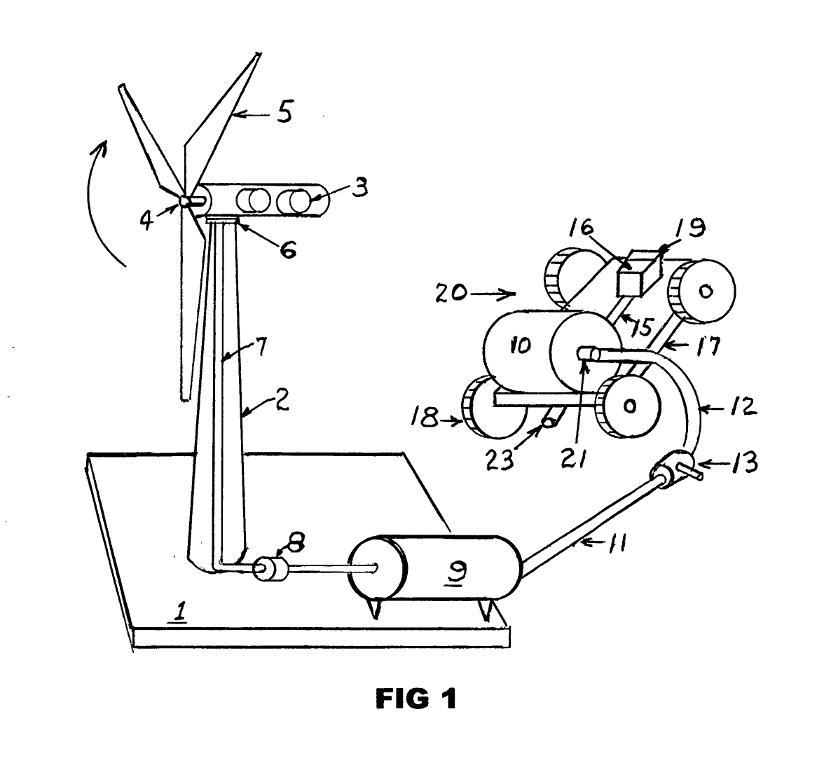

Referring now to the schematic diagram in FIG. 1, the overall invention is seen comprising a source of wind powered compressed air, a facility for accumulating and storing the compressed air and a vehicle utilizing the compressed air as a power source for locomotion. FIG. 1 illustrates the Wind Powered Vehicle System comprising a foundation base unit 1, having mounted thereon a turbine tower 2, with a wind turbine driven turret mounted rotating piston type air compressor 3 mounted on the uppermost end of the tower 2. The wind turbine driven piston type air compressor 3 is mounted on a swivel joint 6 that facilitates turning of the wind turbine and its piston type air compressor into the wind so that the wind turbine blades 5 rotate in response to the wind.

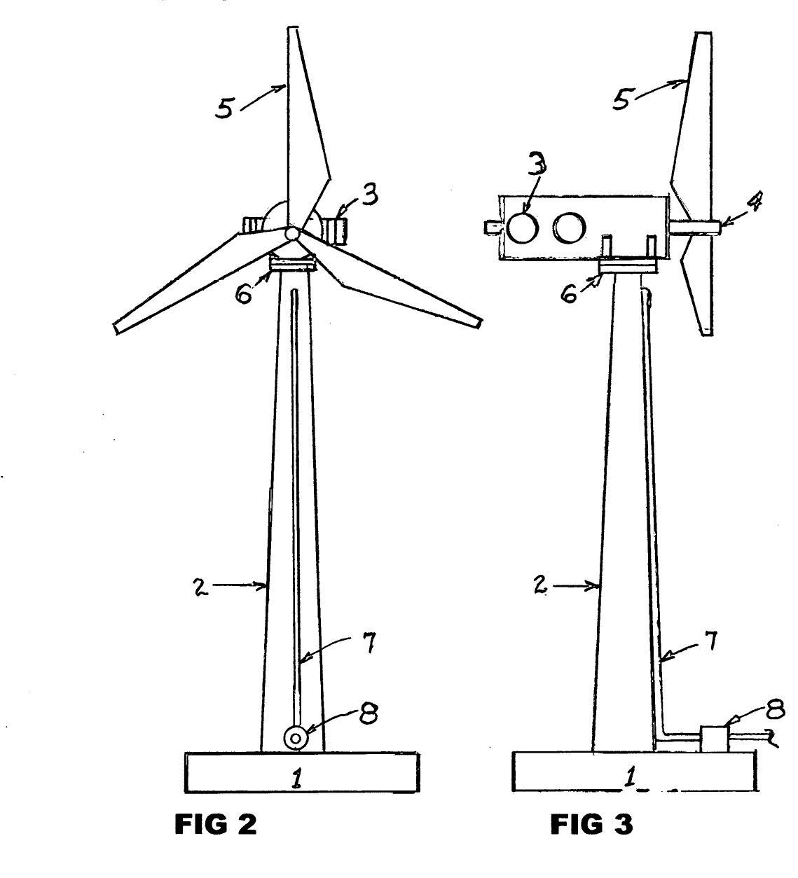

FIGS. 1, 2 and 3 show a very large fixed foundation base 1 that supports a wind turbine that is located and installed in a geographic area that preferably has a relatively high average annual wind speed. This might be on top of a high hill, in an open field, on a sea coast, in a canyon or other location that has an unobstructed flow of strong wind currents. The wind turbine driven piston type air compressor 3 is mounted on top of a tower 2 to avoid wind turbulence ground effects. Wind turbines or wind mills have been manufactured for a very long time in various configurations. This wind turbine is unique because it drives a piston type air compressor 3 that is mounted in the central rotating hub body of the wind turbine. The rotating axle 4 of the wind turbine is driven by wind force which is applied to the air foil or drag type blades 5 which, as they pass through the air, cause the axle 4 to rotate. The rotating wind turbine axle 4 drives a piston type air compressor 3 by a direct drive axle 4, or through a geared or hydraulic transmission. Compressor 3 is a very high pressure air compressor that compresses air to about 4,000 to 5,000 pounds per square inch (psi) pressure. Atmospheric air is drawn into the piston type air compressor 3 where the air is compressed and delivered through a high pressure rotating swivel joint 6 atop tower 2 into a high pressure air supply pipeline 7.

The air supply pipeline 7 runs down the tower 2 to ground level where it delivers compressed air through a one way check valve 8 and into a very large heavily insulated high pressure accumulator air storage tank 9. The large reservoir of high pressure air stored in the tank 9 is a filling station for many vehicles that are powered by compressed air driven piston motors. When atmospheric air is compressed to around 4,000 to 5,000 psi pressure, the air temperature in the storage tank rises a great deal, since heat is part of the stored energy. The air tanks on the filling station and on the vehicle are therefore heavily insulated to conserve the heat stored energy in the compressed air. The stored heat is released in a sudden cool down when the compressed air is released through the vehicle air motor into the open atmosphere. A heated exhaust pipe, shown schematically at reference numeral 23, is situated at the point where the suddenly cold air exits the motor into the open atmosphere. The heated exhaust pipe 23 prevents the formation of freezing ice from the moisture contained in the previously compressed air, since the ice could block the exit of the air from the motor.

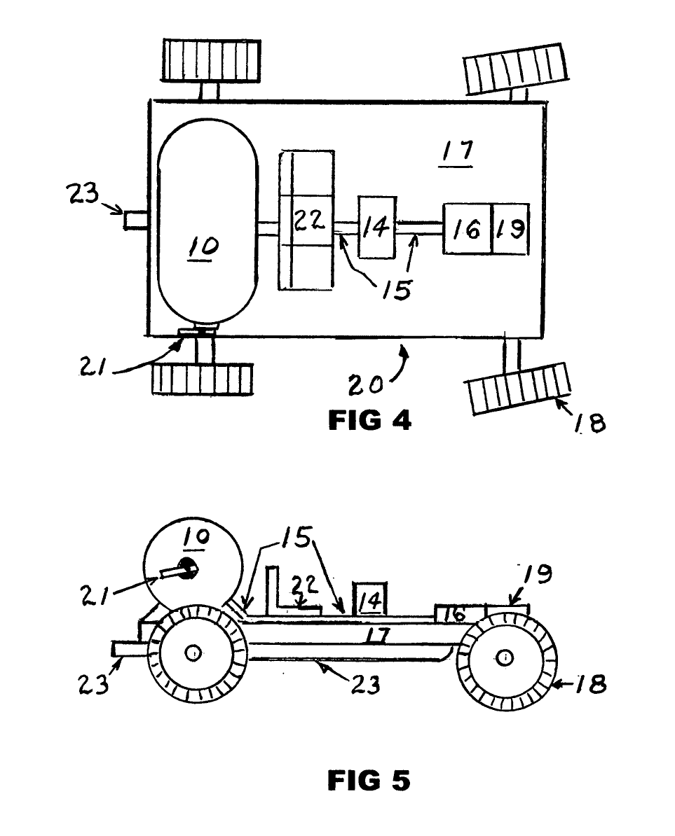

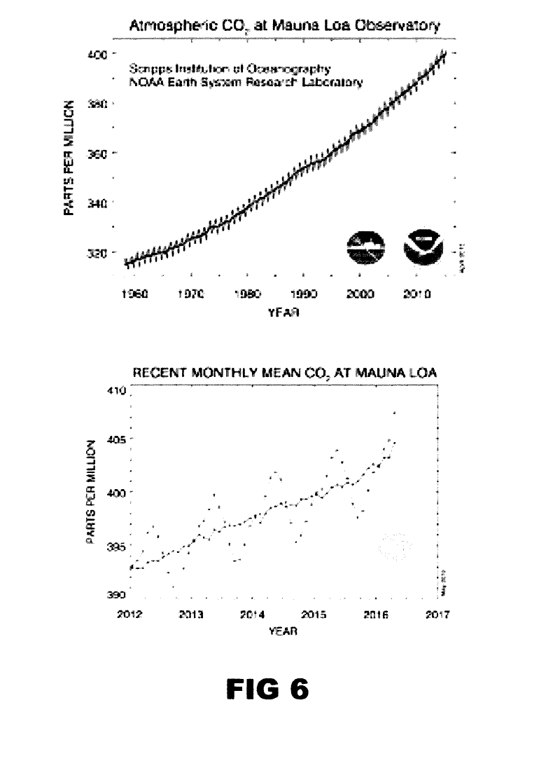

A unique vehicle 20 has a chassis frame 17 that contains a small heavily insulated high pressure compressed air accumulator storage or fuel tank 10 mounted on the vehicle chassis frame 17, as shown in FIGS. 1, 4 and 5. This vehicle heavily insulated air tank 10 is filled with compressed air by a pipeline 11. A flexible high pressure air hose 12 conveys compressed air from the filling station large heavily insulated compressed air tank 9 to compressed air tank 10 on the vehicle. Supply pipeline valve 13 is opened allowing high pressure air to flow from the filling station tank 9 into the vehicle 20 heavily insulated air fuel tank 10 through vehicle tank valve 21. The valves 13 and 21 are closed when the vehicle 20 fuel tank 10 is filled with compressed air. Flexible hose 12 is then disconnected from tank 10, allowing vehicle 20 to depart. The vehicle 20 is fueled with high pressure compressed air. The vehicle 20 control panel 14 contains a vehicle steering wheel, a vehicle braking system and a compressed air pipeline throttle control valve. The compressed air in the vehicle fuel tank 10 is released through the compressed air pipeline throttle control valve in the vehicle control panel 14 by the driver seated in the driver and passenger seats 22. Compressed air flows from the air fuel tank 10 down an air supply pipeline 15, which may itself be heavily insulated, to a piston driven air motor 16 that drives the vehicle 20. The piston driven air motor 16 drives the vehicle wheels 18 through a geared or hydraulic transmission 19. The vehicle 20 is uniquely fueled by high pressure compressed air that drives the piston driven air motor 16. Conventional vehicles that burn gasoline or diesel fuel can be converted or retrofitted with a compressed air fuel tank 10, a compressed air fuel pipeline 15, a compressed air pipeline throttle control valve in the vehicle control panel 14, and a piston driven air motor 16. The compressed air powered vehicle disconnects the flexible fuel line 12 and drives out of the filling station. It drives around depleting its compressed air supply and then it returns to such a filling station for refueling.

All of the components described above are presently manufactured. They are all available for sale including the: wind turbine, air compressor, compressed air storage tank and the compressed air powered vehicle (for example, on information and belief, a compressed air car that may be modified for this purpose is currently advertised as being for sale as the Zero Pollution Motors/MDI Air Car). The Wind Powered Vehicle System is a unique combination or system of existing components that produce an air pollution free vehicle.

Those skilled in the art who have the benefit of this disclosure will recognize that changes can be made to the component parts of the present invention without changing the manner in which those component parts function and/or interact to achieve their intended result. For example, in one embodiment, the vehicle's electric systems are powered by a conventional generator that is turned by the relatively high-velocity air that escapes from air motor 16. The location, shape, and configuration of the exhaust port from air motor 16, and the impeller or other wind vane situated in the exhaust port, are all optimized in accordance with factors known in the art to facilitate the generation of electric power in this manner. All such changes, and others that will be clear to those skilled in the art from this description of several embodiment(s) of the invention, are intended to fall within the scope of the following, non-limiting claims.

What is claimed is:

1. A wind-powered vehicle comprising:
a vehicle having a compressed air-powered motor mounted thereto;
a tank mounted to said vehicle for fueling with compressed air, said tank being provided with hoses and couplings for operably connecting said tank to the motor of said vehicle and for releasably coupling said tank to a source of compressed air;
an air compressor;
a wind turbine having said air compressor mounted in the hub thereof for driving said air compressor, thereby compressing air; and
a high-pressure accumulator air storage tank for receiving compressed air from said air compressor and having an outlet for releasably coupling to said tank mounted to said vehicle.

2. The wind powered vehicle of claim 1 additionally comprising insulation for conserving the heat-stored energy of the compressed air.

3. The wind powered vehicle of claim 2 wherein said insulation is provided around said tank mounted to said vehicle.

4. The wind powered vehicle of claim 1 wherein air is stored in said accumulator air storage tank at pressures of from 4000-5,000 psi.

5. The wind powered vehicle of claim 1 additionally comprising a swivel joint that facilitates turning of said wind turbine into the wind.

6. The wind powered vehicle of claim 1 additionally comprising a heater for resisting ice formation in the exhaust port from the compressed air powered motor.
